(19) United States
(12) Patent Application Publication
(10) Pub. No.: US 2012/0075197 A1
(43) Pub. Date: Mar. 29, 2012

(54) Touch Display

(75) Inventor: Juha Harri-Pekka Nurmi, Salo (FI)

(73) Assignee: NOKIA CORPORATION, Espoo (FI)

(21) Appl. No.: 12/889,378

(22) Filed: Sep. 23, 2010

(51) Int. Cl. G06F 3/041

(52) U.S. Cl. 345/173

(57) ABSTRACT

In an embodiment, a touch display has a plurality of pixel elements and touch sensor elements. The touch display further has a display driver circuitry containing a plurality of output channels each corresponding to a different row of pixel elements of the touch display, and a touch detection driver circuitry containing a plurality of input channels each corresponding to a different row of touch sensor elements. Further, the touch display has a plurality of common communication lines connected to a plurality of first separators. Each of the first separators is connected to a predetermined pixel element and to a predetermined touch sensor element. Each of the common communication lines is further connected to one of the output channels of the display driver and via a second separator to one of the input channels of the touch detection driver.

### TECHNICAL FIELD

The present invention generally relates to a touch display.

### BACKGROUND ART

Touch displays are display devices with integrated touch detection. Typically, touch displays house indiscernible pixel elements and touch detection elements. Each of the pixel elements is individually addressable through a grid of intersecting select lines and refresh lines. Correspondingly, each of the touch detection elements is individually addressable through a grid of intersecting select lines and readout lines.

Many modern portable devices are equipped with relatively large touch displays. The large touch displays require correspondingly large number of lines to address each of the numerous pixel elements and touch detection elements. For instance, let us consider a relatively common touch display that is QVGA display (240×320 pixels×three colors) and that has 120×160 touch detection elements. To address all of the pixel elements, connections or pins are needed for 240×3+320 lines=1040 pins. The touch detection elements require further 120+160 pins=280 pins. In total the display needs 1040+280 pins=1320 pins. The larger the display and the more pixel and/or touch detection elements the display has, the higher the number of required pins is and the more complex and expensive the touch display is.

### SUMMARY

According to a first example aspect of the invention there is provided an apparatus comprising:

a. a touch display comprising a plurality of pixel elements and touch sensor elements;

b. a display driver circuitry comprising a plurality of output channels each corresponding to a different row of pixel elements of the touch display;

c. a touch detection driver circuitry comprising a plurality of input channels each corresponding to a different row of touch sensor elements;

d. a plurality of common communication lines connected to a plurality of first separators, each of the first separators being connected to a predetermined pixel element and to a predetermined touch sensor element;

e. each of the common communication lines being further connected to one of the output channels of the display driver and via a second separator to one of the input channels of the touch detection driver; and

f. wherein the output channels of the display driver circuitry are configured to provide different common communication lines with electric signals configured to enable separately for each of the common communication lines either communication between the output channel connected to the common communication line in question and one pixel element while separating with the first and second separators the input channel and touch sensor element from the common communication line in question, or between the input channel connected to the common communication line in question and one touch sensor element by causing the first and second separators to pass information.

The first separators may comprise directional components configured to communicatively connect a pixel element or a touch sensor element with a corresponding common communication line depending on the polarity of voltage of the common communication line. The directional components may comprise one or more diodes.

The first separators may comprise controllable switches. The controllable switches may comprise semiconductor switches such as transistors and/or microelectromechanical systems (MEMS) relays.

The pixel elements and touch sensor elements that are connected to a common first separator may correspond to different regions of the touch display. The touch sensor elements are distributed such that each touch sensor element corresponds to a region of the touch display that covers a plurality of pixel elements.

The apparatus may further comprise selection lines intersecting with the common communication lines. Each selection line may be communicatively connected with one column of pixel elements. The apparatus may further comprise a third separator configured to selectively activate one of plural columns of the pixel elements by electrically controlling the corresponding selection line. Some of the selection lines may further be communicatively connected to a column of touch sensor elements.

The selection lines and the common communication lines may form a grid.

The number of pixel elements may be higher than the number of the touch sensor elements. A portion of the pixel elements may be associated with dedicated pixel element communication lines to make such pixel elements accessible without first separators. The pixel elements associated with dedicated pixel element communication lines may be associated with common selection lines with the pixel elements and touch sensor elements that are multiplexed to operate over common communication lines. The dedicated pixel element communication lines may be operationally matched with the common communication lines.

The apparatus may be configured to operate the touch sensor elements at a first rate and to operate the pixel elements at a second rate, wherein the first rate is different than the second rate. The first rate may be multiple times higher than the second rate.

According to a second example aspect of the invention there is provided a method comprising:

a. selectively connecting to one of plural common communication lines either one pixel element or touch sensor element of a touch display and one output channel of a display driver circuitry or one input channel of a touch detection driver circuitry, respectively, by providing said one common communication line with electrical signals adapted to cause said selective connecting; and

b. exchanging information over said common communication line between the selectively connected pixel element or touch sensor element and display driver circuitry or touch detection driver circuitry.

The method may further comprise selectively activating one of plural columns of the pixel elements for access over said common communication line.

According to a third example aspect of the invention there is provided a computer program comprising computer executable program code configured to cause an apparatus to perform, when executed by an apparatus, the method of the second example aspect.

The computer program may be stored in a computer readable memory medium.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

Some example embodiments of the invention will be described with reference to the accompanying drawings, in which:

FIG. 1 shows a schematic drawing of a sub-assembly according an example embodiment of the invention;

FIG. 2 shows a schematic drawing of a portion of a touch display and associated drivers of the sub-assembly of FIG. 1;

FIG. 3 shows a signal diagram indicative of various signals and states with reference to FIG. 2; and

FIG. 4 shows a schematic drawing of a portion of a touch display and associated drivers of a sub-assembly according to another example embodiment of the invention.

### DETAILED DESCRIPTION

In the following description, like reference signs denote like elements.

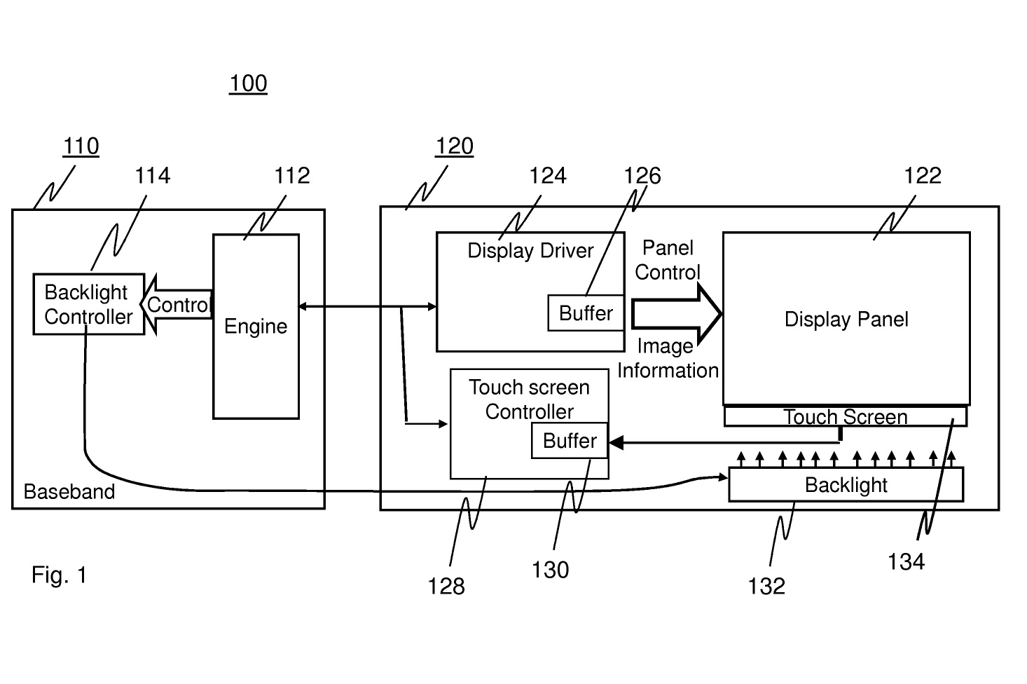

FIG. 1 shows a schematic drawing of a sub-assembly 100 according an example embodiment of the invention. The sub-assembly may be used in a variety of different devices such as portable devices like mobile phones, navigators, personal digital assistant (PDA) devices, gaming devices, and video players. In this example, it is assumed that the sub-assembly is constructed for a mobile phone.

The sub-assembly 100 comprises a baseband part 110, an engine 112 and a backlight controller 114. The sub-assembly further comprises a display module 120 or a touch display that comprises a display panel 122, a display driver 124 circuitry comprising an output buffer 126 and a plurality of output channels. The touch display further comprises a touch screen 134, a touch screen controller 128 or touch detection driver circuitry with an input buffer 130 that has a plurality of input channels, and a backlight 132. The engine 112 is communicatively connected to control the backlight controller 114 that controls the backlight 132. The engine 112 is further communicatively connected with the display driver 124 and with the touch screen controller 128, which drivers control through their respective buffers the display panel 122 and the touch screen 134.

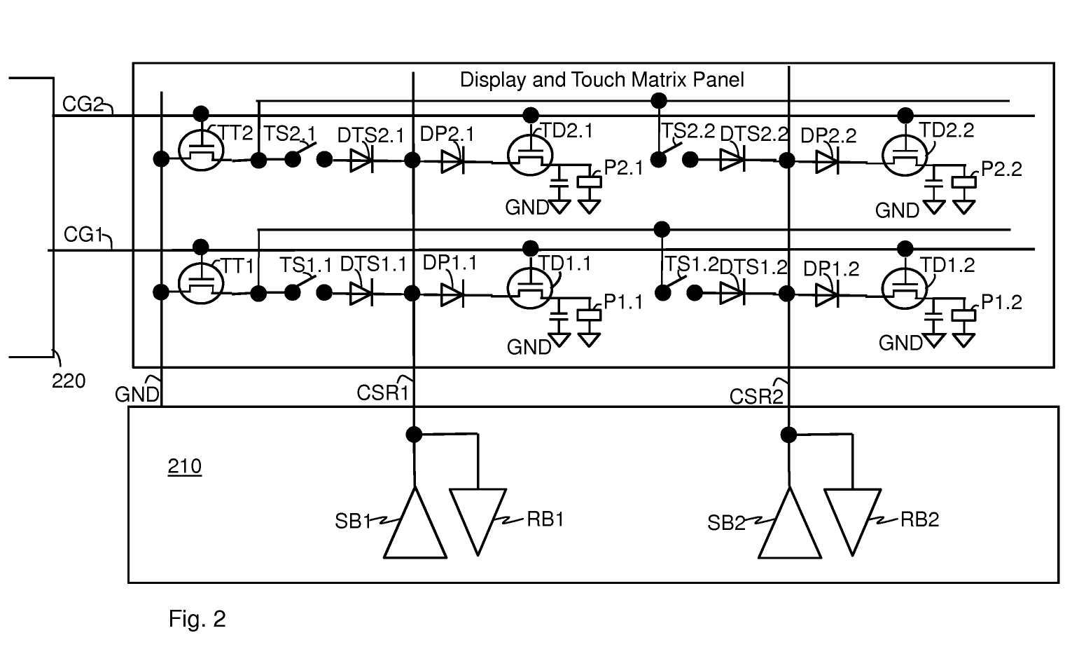

The touch display 120 comprises a plurality of pixel elements (FIG. 2: P1.1, P1.2, P2.1 and P2.2) and a plurality of touch sensor elements (FIG. 2: TS1.1, TS1.2, TS2.1 and TS2.2).

FIG. 2 shows a schematic drawing of a portion of a touch screen and associated drivers of the sub-assembly 100 of FIG. 1. Out of a large number of different common gate lines (also referred to as common selection lines) only two are shown with reference signs CG1 and CG2. Likewise, FIG. 2 shows only two of many common source and readout lines or common communication lines, denoted as CSR1 and CSR2.

The common gate lines are controlled by a common gate circuitry 220 to activate pixel elements and touch sensors connected to activate respectively connected pixel elements and touch sensor elements by rows. One common gate line activates at most one pixel element and one touch sensor for each common communication line. For instance, when feeding a given activation voltage such as +5 V through a first common gate line CG1, the corresponding gate circuits TT1, TD1.1 and TD1.2 enable operation of touch sensors and pixel elements along one row, here logically understood as row 1. Likewise, when a second common gate line CG2 is activated by the common gate circuitry 220, the second row is enabled by corresponding gate circuits TT2, TD2.1 and TD2.2.

Both rows intersect with two different common communication lines, CSR1 and CSR2. The intersection of one common gate line and one common communication line thus uniquely identifies one pixel element and one touch sensor.

In FIG. 2, each touch sensor element and each pixel element is connected to one (typically nearest) common communication line through a diode (DTS1.1, DTS1.2, DTS2.1, DTS2.2; DP1.1, DP1.2, DP2.1 and DP2.2) such that voltage of the common communication that is higher than threshold level of the diodes and with a first polarity will enable the touch sensor elements to communicate over the common communication line. Correspondingly, voltage exceeding the threshold level of the diode with polarity to the first polarity enables the pixel elements to communicate over the common communication line. However, only one touch sensor element or pixel element may communicate at the time thanks to the common gate lines that activate only one row of touch sensor elements and pixel elements at the time.

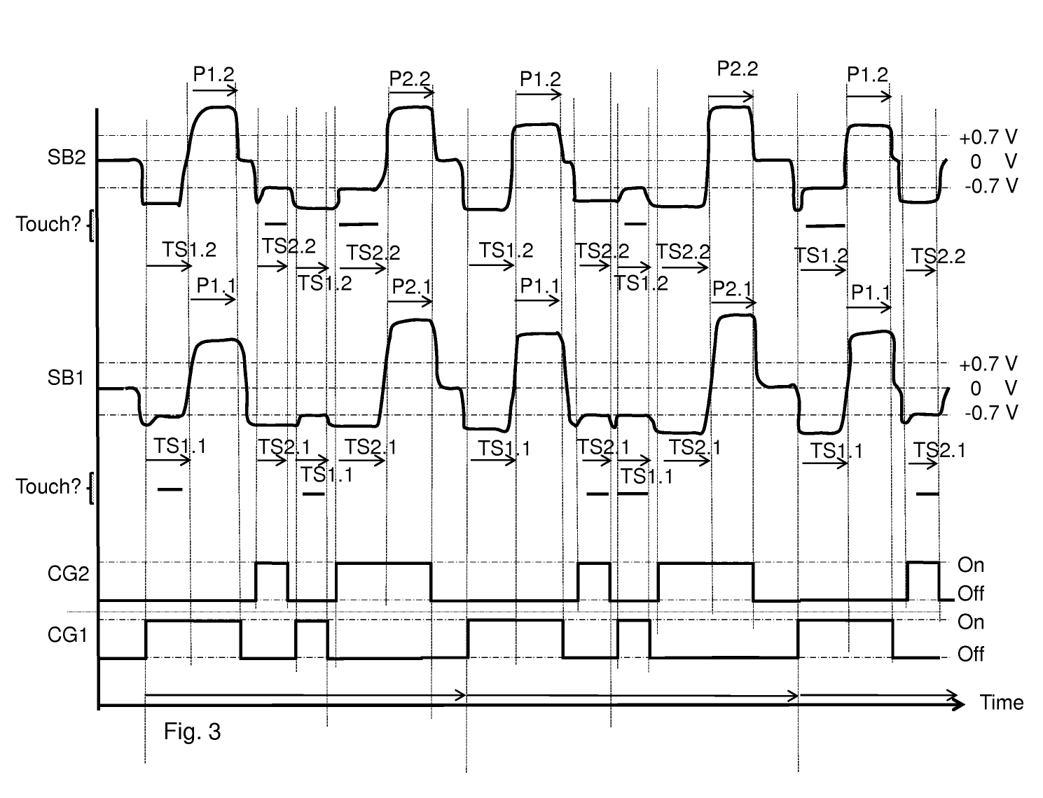

For instance, let us assume that the second row is activated by feeding an activating voltage through the second common gate line CG2. In response, the gate circuit TT2 becomes conductive and grounds one side of the sensor elements on the second row (TS2.1 and TS2.2) and the gate circuits that control the pixel elements on the second row. Next, the touch sensor of the first column or first common communication line CSR1 is being read. The first output buffer SB1 yields a voltage lower than −0.7 V (assuming −0.7 V corresponding to threshold of the diodes controlling communication access of the touch sensor elements). When a user touches the screen and makes the touch sensor element TS2.1 conductive, a current flows from the ground through the diode DTS2.1 and cuts the voltage at readout buffer RB1 to 0 V (ground)−0.7 V (diode's threshold)=−0.7 V. FIG. 3 demonstrates changes in the voltage at the first and second source buffers SB1 and SB2 that signify connection at a touch sensor element. On the other hand, when the first output buffer SB1 yields a voltage above +0.7 V, the pixel element that is at the intersection of the activated row and the first output buffer gets the voltage that is supplied onto the common communication line less the threshold voltage of the diode. For instance, if +2 V is supplied onto the common communication line, the pixel element receives +2−0.7 V=1.3 V. Hence, the diodes can be understood as directional elements. The diodes may also be seen as controllable switches or separators that let suitable electric signals to pass through the separators and enable communication with the elements behind the separators, provided that the elements are on an activated row.

FIG. 3 shows a signal diagram indicative of various signals and states with reference to FIG. 2. It can be seen in FIG. 3 that there each pixel element is refreshed (communicated with) at a frequency that is half of that of the frequency with which the touch sensor elements are communicated with. In other words, one common gate line may be used in time division mode so that display refresh rate and touch scanning frequencies may be different. For instance, the display may be refreshed at a rate of 60 Hz and the touch scanning may be run at a rate of is 80 Hz or 120 Hz. Moreover, the number of the pins (as well as connections) needed to communicate with a touch display may be drastically reduced. For instance, with a 240×320 RGB (red-green-blue) display panel and 120×160 touch screen, (320 pins and 160 pins being multiplexed) results in required pins being 240×3+320=1040 pins.

The type of the touch sensor elements is not restricted. The touch sensor elements may be mechanical, optical, capacitive, or work with any other operating principle.

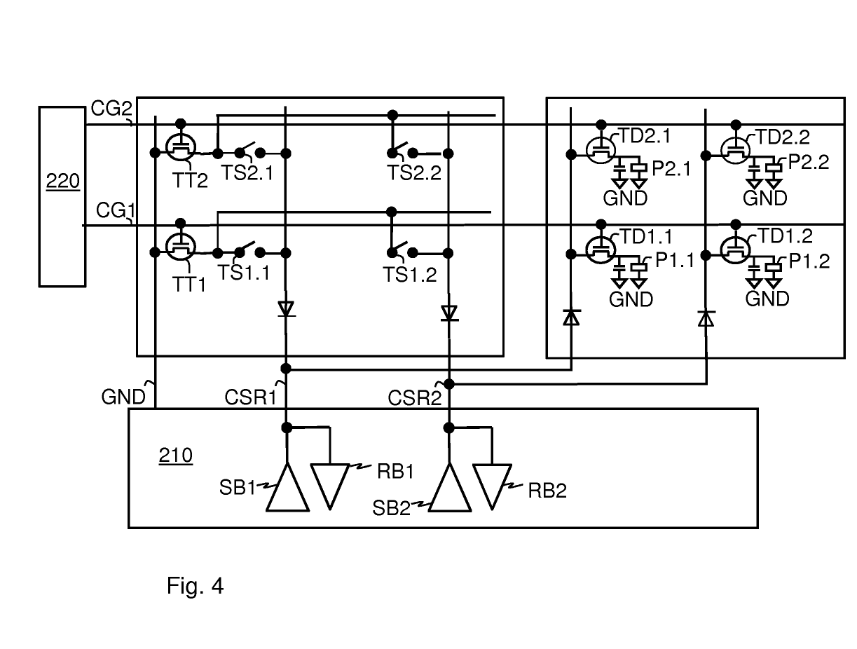

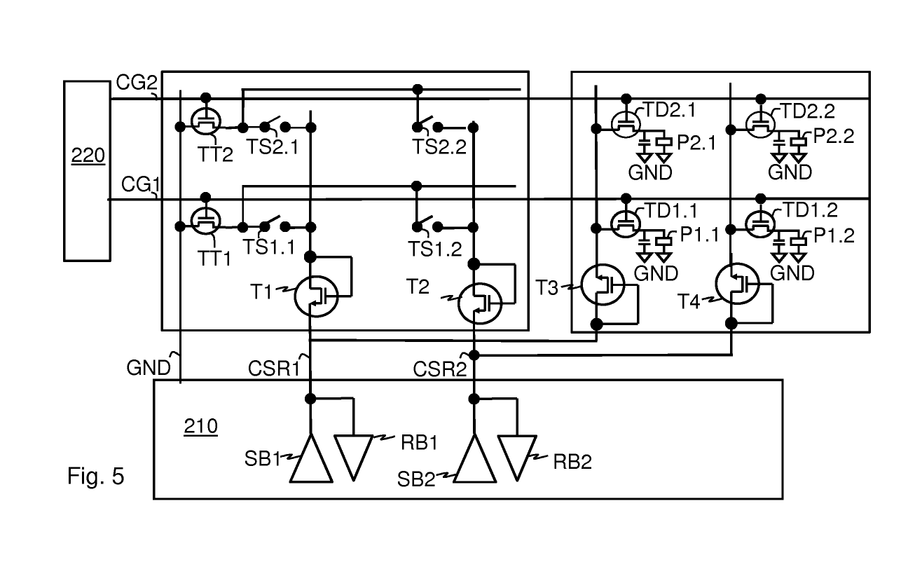

FIG. 4 shows a schematic drawing of a portion of a touch screen and associated drivers of a sub-assembly according to another example embodiment of the invention. FIG. 4 differs from FIG. 3 in that there is only one separator per each common communication line in each of a touch matrix panel and a display panel. Hence, the number of separators needed is far lower than in FIG. 3. On the other hand, separate lines have to be provided behind each separator for one column of touch sensor elements or pixel elements.

The connection presented in FIG. 4 may be used e.g. when a touch screen is stacked over a display panel. However, the same principle is applicable also to a display integrated touch screen.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention. For instance, instead of using directional elements as separators or controllable switches, various other components are usable to selectively form desired communication paths between touch display controllers and individual pixel elements and touch sensor elements. For instance, transistors or microelectromechanical (MEMS) relays are applied in particular further example embodiments. FIG. 5 shows an example of a variant of FIG. 4 with NMOS enhancement MOSFET transistors (T1 to T4). The transistors are connected as in a so-called diode-connection wherein the Gate and Drain are connected together. It is appreciated that similarly, some or all of the diodes in FIG. 2 may be replaced by controllable switches such as transistors or MEMS relays.

The appended abstract is incorporated by reference as part of this description.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

What is claimed is:

1. An apparatus comprising:
a touch display comprising a plurality of pixel elements and touch sensor elements;
a display driver circuitry comprising a plurality of output channels each corresponding to a different row of pixel elements of the touch display;
a touch detection driver circuitry comprising a plurality of input channels each corresponding to a different row of touch sensor elements;
a plurality of common communication lines connected to a plurality of first separators, each of the first separators being connected to a predetermined pixel element and to a predetermined touch sensor element;
each of the common communication lines being further connected to one of the output channels of the display driver and via a second separator to one of the input channels of the touch detection driver; and
wherein the output channels of the display driver circuitry are configured to provide different common communication lines with electric signals configured to enable separately for each of the common communication lines either communication between the output channel connected to the common communication line in question and one pixel element while separating with the first and second separators the input channel and touch sensor element from the common communication line in question, or between the input channel connected to the common communication line in question and one touch sensor element by causing the first and second separators to pass information.

2. The apparatus of claim 1, wherein the first separators comprise directional components configured to communicatively connect a pixel element or a touch sensor element with a corresponding common communication line depending on the polarity of voltage of the common communication line.

3. The apparatus of claim 2, wherein the directional components comprise one or more diodes.

4. The apparatus of claim 1, wherein the pixel elements and touch sensor elements that are connected to a common first separator correspond to different regions of the touch display.

5. The apparatus of claim 1, wherein the touch sensor elements are distributed such that each touch sensor element corresponds to a region of the touch display that covers a plurality of pixel elements.

6. The apparatus of claim 1, further comprising selection lines intersecting with the common communication lines.

7. The apparatus of claim 6, wherein each selection line communicatively connected with one column of pixel elements.

8. The apparatus of claim 6, further comprising a third separator configured to selectively activate one of plural columns of the pixel elements by electrically controlling the corresponding selection line.

9. The apparatus of claim 7, further comprising a third separator configured to selectively activate one of plural columns of the pixel elements by electrically controlling the corresponding selection line.

10. The apparatus of claim 8, wherein some of the selection lines are further communicatively connected to a column of touch sensor elements.

11. The apparatus of claim 6, wherein the selection lines and the common communication lines form a grid.

12. The apparatus of claim 7, wherein the selection lines and the common communication lines form a grid.

13. The apparatus of claim 8, wherein the selection lines and the common communication lines form a grid.

14. The apparatus of claim 1, wherein the number of pixel elements is higher than the number of the touch sensor elements.

15. The apparatus of claim 1, wherein a portion of the pixel elements is associated with dedicated pixel element communication lines to make such pixel elements accessible without first separators.

16. The apparatus of claim 15, wherein the pixel elements associated with dedicated pixel element communication lines are associated with common selection lines with the pixel elements and touch sensor elements that are multiplexed to operate over common communication lines.

17. The apparatus of claim 16, wherein the dedicated pixel element communication lines are operationally matched with the common communication lines.

18. The apparatus of claim 1, further configured to operate the touch sensor elements at a first rate and to operate the pixel elements at a second rate, wherein the first rate is different than the second rate.

19. A method comprising:
selectively connecting to one of plural common communication lines either one pixel element or touch sensor element of a touch display and one output channel of a display driver circuitry or one input channel of a touch detection driver circuitry, respectively, by providing said one common communication line with electrical signals adapted to cause said selective connecting; and
exchanging information over said common communication line between the selectively connected pixel element or touch sensor element and display driver circuitry or touch detection driver circuitry.

20. The method of claim 19, further comprising selectively activating one of plural columns of the pixel elements for access over said common communication line.
